(19) United States
(12) Patent Application Publication
(10) Pub. No.: US 2021/0136189 A1
(43) Pub. Date: May 6, 2021

(54) ELECTRONIC DEVICE AND FRONT SHELL THEREOF

(71) Applicant: GUANGDONG OPPO MOBILE TELECOMMUNICATIONS CORP., LTD., Dongguan (CN)

(72) Inventors: Shenbo YAN, Dongguan (CN); Heng ZHANG, Dongguan (CN); Yongliang YUAN, Dongguan (CN); Junkun YANG, Dongguan (CN)

(21) Appl. No.: 17/149,228

(22) Filed: Jan. 14, 2021

Related U.S. Application Data
(63) Continuation-in-part of application No. PCT/CN2018/095799, filed on Jul. 16, 2018.

(51) Int. Cl. H04M 1/02; G06F 3/041

(52) U.S. Cl. CPC H04M 1/0266; G06F 3/04164; G06F 3/0412

(57) ABSTRACT

The present disclosure relates to an electronic device including a frame, a screen assembly, and a sensor assembly. The frame defines a receiving space and at least one transmission channel is communicating with the receiving space, the at least one transmission channel includes a first end and a second end opposite to the first end. The screen assembly is connected to the frame. The screen assembly includes a display portion and a non-display portion connected to the display portion. The non-display portion covers the first end. The sensor assembly is disposed in the receiving space. The sensor assembly is adjacent to the second end, and opposite to the non-display portion via the at least one transmission channel. The sensor assembly is configured to transmit and/or receive signals that pass through the at least one transmission channel and the non-display portion.

### CROSS-REFERENCE TO RELATED APPLICATION

This application is a continuation-in-part of International Application No. PCT/CN2018/095799, filed Jul. 16, 2018, the entire disclosure of which is incorporated herein by reference.

### TECHNICAL FIELD

The present disclosure relates to the field of electronic devices in general. More particularly, and without limitation, the disclosed embodiments relate to a front shell, an electronic device with a sensor assembly.

### BACKGROUND

With the development of electronic technology, electronic devices such as smart phones or tablet computers have become widely used. With the rapid development of electronic display devices such as smart phones, users' requirement for display performance of electronic products has gradually increased. The design of full-screens (ultra-narrow bezels) has become the mainstream direction of current research. To achieve a full-screen, it is necessary to re-layout electronic components (such as cameras, sensors, etc.) on the display screen to avoid such devices occupying too much space.

### SUMMARY

For a first aspect, an electronic device is provided, in accordance with an embodiment of the present disclosure. The electronic device includes a frame, a screen assembly, and a sensor assembly. The frame defines a receiving space and at least one transmission channel is communicating with the receiving space, the at least one transmission channel includes a first end and a second end opposite to the first end. The screen assembly is connected to the frame. The screen assembly includes a display portion and a non-display portion connected to the display portion. The non-display portion covers the first end. The sensor assembly is disposed in the receiving space. The sensor assembly is adjacent to the second end, and opposite to the non-display portion via the at least one transmission channel. The sensor assembly is configured to transmit signals to pass through the at least one transmission channel and the non-display portion, and/or receive signals that passes though the non-display portion and the at least one transmission channel.

For a second aspect, a, an electronic device is provided, in accordance with another embodiment of the present disclosure. The electronic device includes a housing, a screen assembly, and a sensor assembly. The housing defines at least one transmission channel therein. The screen assembly is connected to the housing. The screen assembly includes a display portion and a non-display portion; the non-display portion is connected to an edge of the display portion. The non-display portion is attached to the housing. The sensor assembly is disposed in the housing. The sensor assembly and the non-display portion are respectively located at two opposite ends of the at least one transmission channel. The non-display portion defines a transmission region. The transmission region is aligned to the at least one transmission channel and configured to allow signals from the sensor assembly to pass through.

For a third aspect, a front shell for an electronic device is provided, in accordance with one embodiment of the present disclosure. The front shell includes a frame and a mounting member connected to the mounting member. The frame comprises a mounting surface and a support surface connected to the mounting surface. The mounting surface is an interior surface of the frame and defines a receiving space for accommodate electronic components of the electronic device. The mounting member is connected to the mounting surface. The support surface is departing from the mounting member; the frame defines at least one transmission channel communicating with the receiving space. The at least one transmission channel penetrates the support surface. The support surface is configured to support a display assembly of the electronic device. The at least one transmission channel is covered by the display assembly when the display assembly is disposed on the support surface.

In the electronic device provided by the embodiments of the present disclosure, the non-display portion of the display assembly is stacked on the frame. The at least one transmission channel is defined in the frame, which can make full use of the non-display portion and a gap defined by a connection structure of the frame and the display assembly, to form a signal transmission channel or path for the sensor assembly. Therefore, the sensor assembly can be flexibly and rationally arranged without embedding into the non-display portion of the screen assembly, thus avoiding occupying a side frame of the electronic device, which is conducive to achieve a full-screen for the electronic device.

### BRIEF DESCRIPTION OF THE DRAWINGS

In order to explain the technical solutions in the embodiments of the present disclosure or the prior art more clearly, the drawings used in the description of the embodiments or the prior art are briefly introduced below. Obviously, the drawings in the following description are merely some embodiments of the present disclosure. For those of ordinary skill in the art, other drawings can be obtained according to these drawings without paying creative labor.

FIG. 1 illustrates a perspective view of an electronic device, in accordance with an embodiment of the present disclosure.

FIG. 2 illustrates a front projection view of the electronic device illustrated in FIG. 1.

FIG. 3 illustrates an enlarged schematic view of area III in the electronic device illustrated in FIG. 2.

FIG. 4 illustrates a perspective view of a partial structure of the electronic device illustrated in FIG. 1, in accordance with one embodiment of present disclosure.

FIG. 5 illustrates a perspective exploded view of the partial structure of a housing and a screen assembly of the electronic device illustrated in FIG. 4.

FIG. 6 illustrates a perspective view of a partial structure of the electronic device illustrated in FIG. 1, in accordance with another embodiment of present disclosure.

FIG. 7 and FIG. 8 illustrate a perspective exploded view of the partial structure of a housing and a screen assembly of the electronic device illustrated in FIG. 4.

FIG. 9 illustrates a schematic view of a partial structure of the housing and the screen assembly of the electronic device illustrated in FIG. 4.

FIG. 10 illustrates another perspective exploded view of a partial structure of the electronic device illustrated in FIG. 5, taken from the other aspect.

FIG. 11 illustrates a schematic cross-sectional view of a partial structure of the electronic device illustrated in FIG. 4.

FIG. 12 illustrates a front projection view of an electronic device, in accordance with another embodiment of the present disclosure.

FIG. 13 illustrates a schematic diagram of a hardware module of an electronic device. In accordance with still another embodiment of the present disclosure.

### DETAILED DESCRIPTION OF EMBODIMENTS

This description and the accompanying drawings that illustrate exemplary embodiments should not be taken as limiting. Various mechanical, structural, electrical, and operational changes may be made without departing from the scope of this description and the claims, including equivalents. In some instances, well known structures and techniques have not been shown or described in detail so as not to obscure the disclosure. Similar reference numbers in two or more figures represent the same or similar elements. In some embodiments, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

As used herein, a “communication terminal”, “electronic device” or simply a “terminal”) includes, but is not limited to, a device that is configured to receive/transmit communication signals via a wire line connection, such as via a public-switched telephone network (PSTN), digital subscriber line (DSL), digital cable, a direct cable connection, and/or another data connection/network, and/or via a wireless interface with, for example, a cellular network, a wireless local area network (WLAN)1 a digital television network such as a DVB-H network, a satellite network, an AM/FM broadcast transmitter, and/or another communication terminal. A communication terminal or an electronic device that is configured to communicate over a wireless interface may be referred to as a “wireless communication terminal,” a “wireless terminal” and/or a “mobile terminal.” Examples of mobile terminals and electronic devices include, but are not limited to, a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

During the implementation of this application, the inventor discovered that, in terms of hardware, a sensor assembly exposed on the front of an electronic device may be a problem to be solved when achieving a full screen of the electronic device. The sensor assembly is configured to detect a distance of the electronic device and an object in front of the electronic device (such as a human face, palm, etc.). When the distance is smaller than a preset distance, a screen of the electronic device is automatically turned off to avoid a disoperation caused by the object when the object touches the screen. The sensor assembly is usually disposed on an upper portion of the front of the screen and embedded in an edge of the screen. A certain room besides the edge of the screen should be reserved for accommodating the sensor assembly. Therefore, the full screen may not be achieved. Therefore, the inventor is committed to studying how to reduce an edge width of the screen by improving the structure or mounting structure of the sensor assembly to increase the screen-to-body ratio.

The inventor found that in an existing electronic device, a screen assembly of the electronic device is usually covered on a housing of the electronic device. The screen assembly and the housing cooperatively form an appearance of the electronic device. A sensor assembly is usually embedded into the screen assembly. In particular, the sensor assembly is usually embedded into and mounted on an edge of the screen assembly, which makes a frame of the screen assembly has a great width (or forms a wider “black border” in the popular sense), which results in a poor user experience, and the full screen may not be achieved. Therefore, after a lot of research, the inventor has concluded that by changing the path and/or manner of the sensor assembly receiving and transmitting signals, a mounting position of the sensor assembly can be changed to avoid the sensor assembly occupying the space at the edge of the screen assembly.

Therefore, in order to improve the user experience and reduce the width of the frame of the screen assembly as much as possible (that is, reduce the width of the “black border” of the screen assembly), the inventor provides an electronic device after a lot of research. The sensor assembly is disposed in the housing. At least one transmission channel is defined in the housing. The sensor assembly and the screen assembly are respectively arranged at two ends of the at least one transmission channel. The sensor assembly may transmit and receive signals through the at least one transmission channel and the screen assembly, which may avoid embedding the sensor assembly into the screen assembly. Therefore, the width of the frame of the screen assembly is reduced, which is conducive to achieve a full screen.

In particular, an electronic device is provided, in accordance with an embodiment of the present disclosure. The electronic device includes a frame, a screen assembly, and a sensor assembly. The frame defines at least one transmission channel. The at least one transmission channel includes a first end and a second end opposite to the first end. The screen assembly is connected to the frame. The screen assembly includes a display portion and a non-display portion. The non-display portion is connected to an edge of the display portion. The non-display portion covers the first end of the at least one transmission channel. The sensor assembly is disposed in a receiving space defined by the frame and is adjacent to the second end of the at least one transmission channel. The sensor assembly is opposite to the non-display portion. The sensor assembly transmits and receives signals through the at least one transmission channel and the non-display portion. For example, the sensor assembly is configured to emit signal to pass through the at least one transmission channel and the non-display portion, and receive signals from outside and pass through the non-display portion and the at least one transmission channel.

Further, an electronic device is also provided, in accordance with another embodiment of the present disclosure. The electronic device includes a housing, a screen assembly, and a sensor assembly. The housing defines at least one transmission channel. The screen assembly includes a display portion and a non-display portion. The non-display portion is connected to an outer periphery of the display portion. The non-display portion covers the housing. The sensor assembly is disposed in a receiving space defined by the housing. The sensor assembly and the non-display portion are respectively disposed at opposite ends of the at least one transmission channel. The sensor assembly transmits and receives through the at least one transmission channel and the non-display portion signal. For example, the sensor assembly is configured to emit signal to pass through the at least one transmission channel and the non-display portion, and receive signals from outside and pass through the non-display portion and the at least one transmission channel.

In the electronic device provided in the present disclosure, the sensor assembly is disposed in the housing of the electronic device. By defining the at least one transmission channel in the housing, the sensor assembly may transmit and receive signals through the at least one transmission channel. So that the sensor assembly can be disposed in the housing flexibly, and the sensor assembly may be reasonably arranged in the housing without embedding into an edge of the screen assembly, thus avoiding the sensor assembly from occupying the frame of the electronic device, which is beneficial to achieves a full screen for the electronic device.

In the embodiments of the present disclosure, the type of the electronic device is not limited. To take a reference, for a common placement of the electronic device in use, “front side of the electronic device” may indicate a side of the electronic device facing a user; “back side of the electronic device” may indicate a side of the electronic device departing from the user; “top portion” may indicate a portion of the electronic device that adjacent to an upper edge of the electronic device; and “bottom portion” may indicate a portion of the electronic device that adjacent to a lower edge of the electronic device. The technical solutions according to the embodiments of the present disclosure will be clearly and completely described below in conjunction with the drawings in the embodiments of the present disclosure.

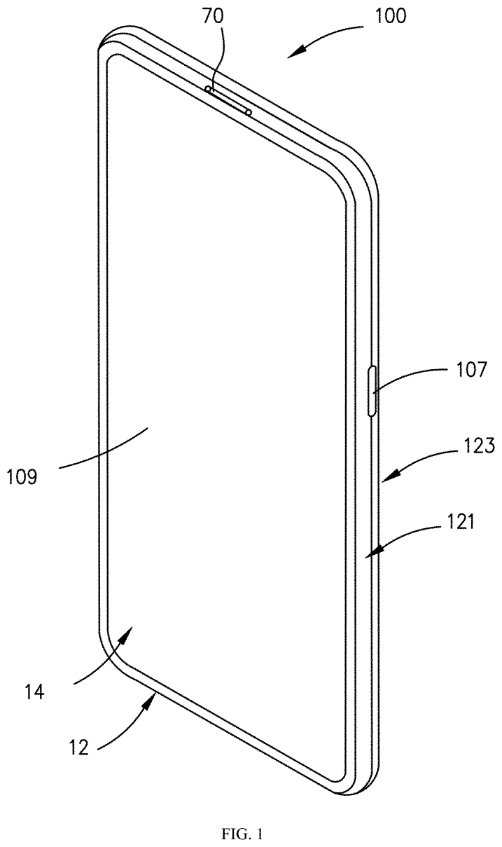

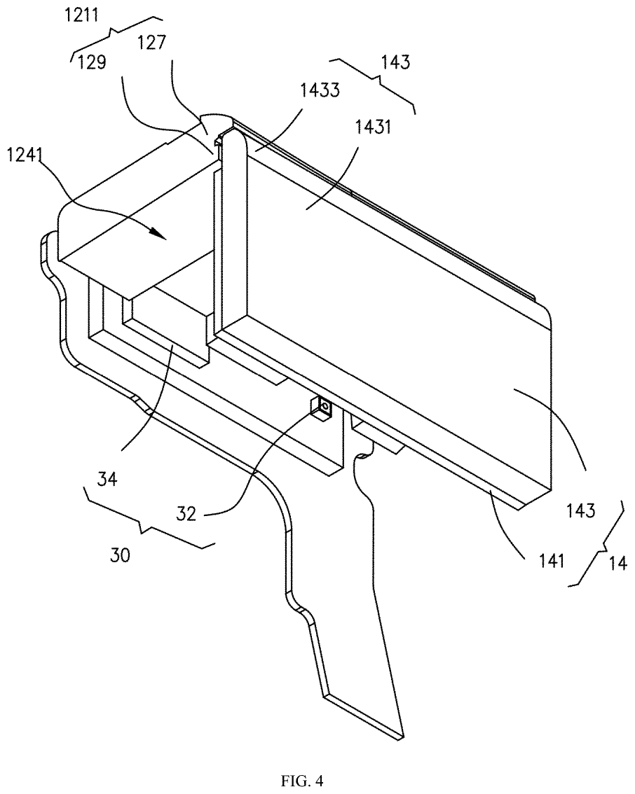

As illustrated in FIG. 1 to FIG. 5, an electronic device 100 is provided, in accordance with an embodiment of the present disclosure. The electronic device 100 can be, but is not limited to, an electronic device such as a mobile phone, a tablet computer, or a smart watch, etc. The electronic device 100 of this embodiment is described by taking a mobile phone as an example. The electronic device 100 includes a housing 12, a screen assembly 14 and a sensor assembly 30. The screen assembly 14 is connected to the housing 12. The housing 12 defines at least one transmission channel 125. The sensor assembly 30 is disposed in the housing 12 and corresponds to the at least one transmission channel 125.

In the illustrated embodiment, the sensor assembly 30 may include at least one sensing end for emitting and receiving signals. The sensing end is opposite to the at least one transmission channel 125. In some embodiments, the sensing end is aligned with the at least one transmission channel. For example, the sensing end may define an axis that indicates a direction of the signals emitted or received by the sensor assembly 30, and the axis may be substantially aligned with a center axis of the at least one transmission channel. The at least one transmission channel 125 is configured to provide at least one transmission channel and/or path for signals of the sensor assembly 30 to pass through. So that the sensor assembly 30 can transmit or/and receive signals through the at least one transmission channel 125, to detect a distance between the electronic device 100 and an object in front of the electronic device 100 (such as the human face, palm, etc.), so as to allow the screen assembly 14 to automatically turn off when the distance between the electronic device 100 and the object is smaller than a predetermined distance. Thus a misoperation caused by the object touching the screen assembly 14 is avoided.

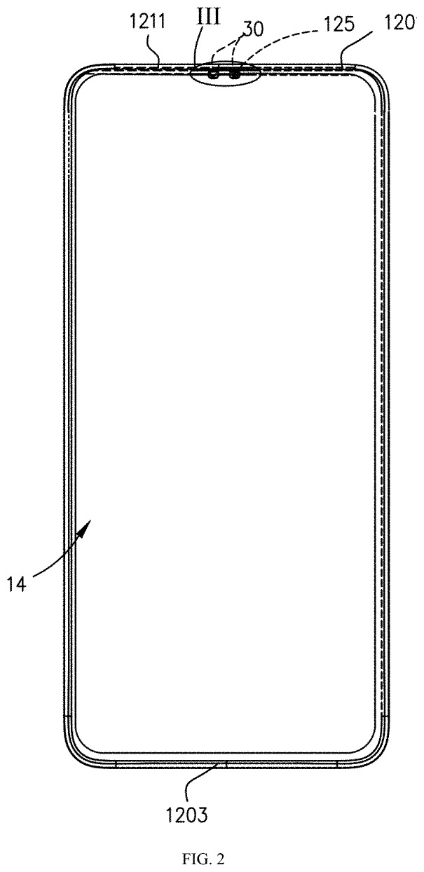

The housing 12 is configured to support the screen assembly 14 and receive other electronic components of electronic device 100. A structure of the housing 12 is not limited. As illustrated in the embodiment of FIGS. 1 and 2, the housing 12 includes a front shell 121 and a rear shell 123. The screen assembly 14 substantially covers one side of the front shell 121. The rear shell 123 is disposed on a side of the front shell 121 away from the screen assembly 14.

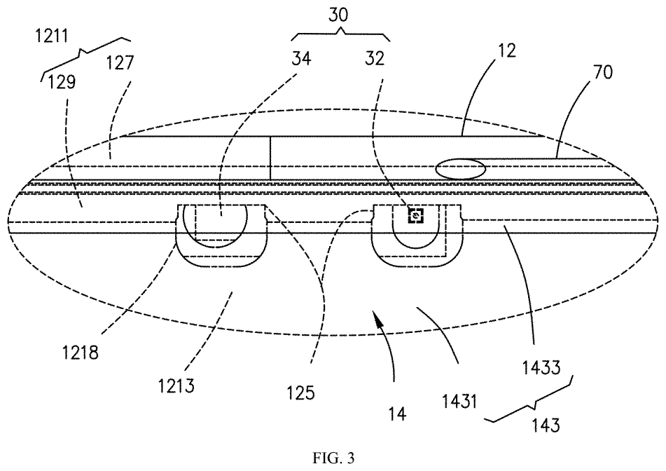

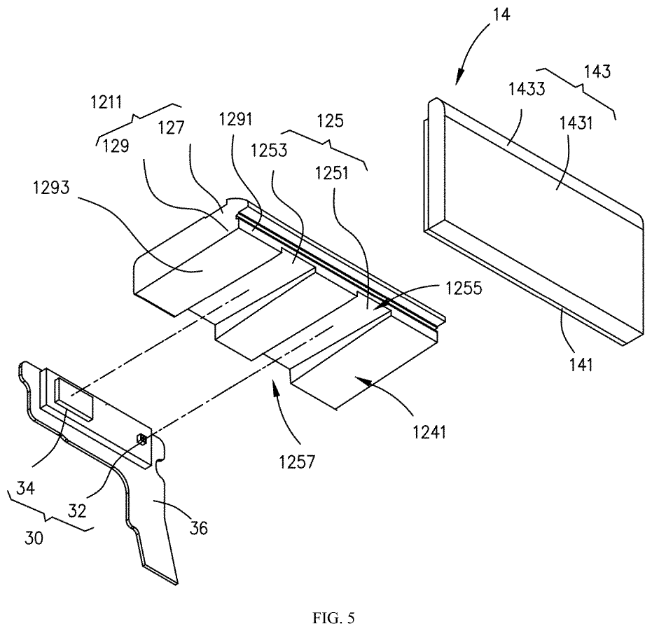

As illustrated in FIGS. 3 to 5, in some embodiments, the front shell 121 includes a frame 1211. In this embodiment, the frame 1211 is substantially in the shape of a rectangular frame with rounded corners. The frame 1211 defines a receiving space 1241. The receiving space 1241 is configured to accommodate the mounting member 1213. The frame 1211 defines at least one transmission channel 125 therein. The at least one transmission channel 125 includes a first end 1255 and a second end 1257 opposite to the first end 1255 (as illustrated in FIG. 5). In this embodiment, the at least one transmission channel 125 is defined in a groove structure. The at least one transmission channel 125 is defined in a side of the frame 1211 facing the receiving space 1241 and corresponds to an edge of the screen assembly 14. The first end 1255 is adjacent to the screen assembly 14. The second end 1257 is far away from the screen assembly 14 with respect with the first end 1255. It can be understood that a location of the at least one transmission channel 125 is not limited. For example, the at least one transmission channel 125 can be defined in one or more of the top, left, right, and bottom portions of the frame 1211. It should be understood that the meanings of the above-mentioned “top”, “left”, “right”, and “bottom” can be understood as follows: when the user uses the electronic device 100 and the screen assembly 14 faces a face of the user, the “top portion” may indicate an edge portion of the electronic device 100 that is adjacent to eyes of the user; the “left portion” may indicate an edge portion of the electronic device 100 that is adjacent to a left shoulder of the user; the “right portion” may indicate an edge portion of the electronic device 100 that is adjacent to a right shoulder of the user; the “bottom portion” may indicate an edge portion of the electronic device 100 that is adjacent to a chin of the user. In the embodiments illustrated in FIGS. 2 and 3, the at least one transmission channel 125 is located at the top portion of the frame 1211.

In some embodiments, the frame 1211 includes a main body 127 and a support portion 129. The main body 127 is substantially in the shape of a rectangular frame. The support portion 129 is disposed on a side of the main body 127 facing the receiving space 1241 and protrudes from the main body 127.

The support portion 129 includes a support surface 1291 and a mounting surface 1293. The support surface 1291 is connected to the main body 127. The support surface 1291 is configured to connect with the screen assembly 14. The mounting surface 1293 is disposed on a side of the support portion 129 and is connected to the supporting surface 1291. In this embodiment, the mounting surface 1293 is substantially perpendicular to the support surface 1291. The mounting surface 1293 in an interior surface of the frame 1211 and defines the receiving space 1241. The at least one transmission channel 125 is defined in the mounting surface 1293. The at least one transmission channel 125 is a groove in the mounting surface 1293. The first end 1255 of the at least one transmission channel 125 penetrates the support surface 1291. The first end 1255 is opposite to the screen assembly 14, so that the screen assembly 14 may cover the first end 1255.

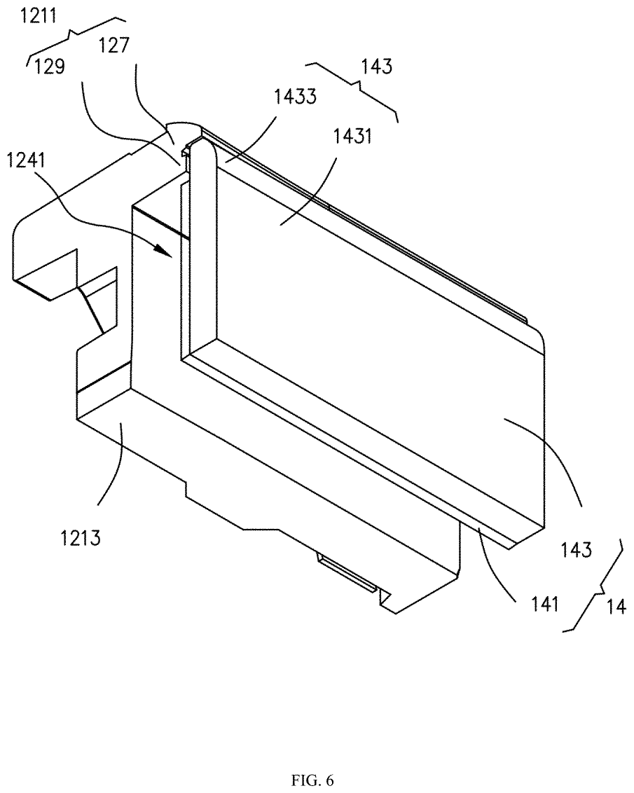

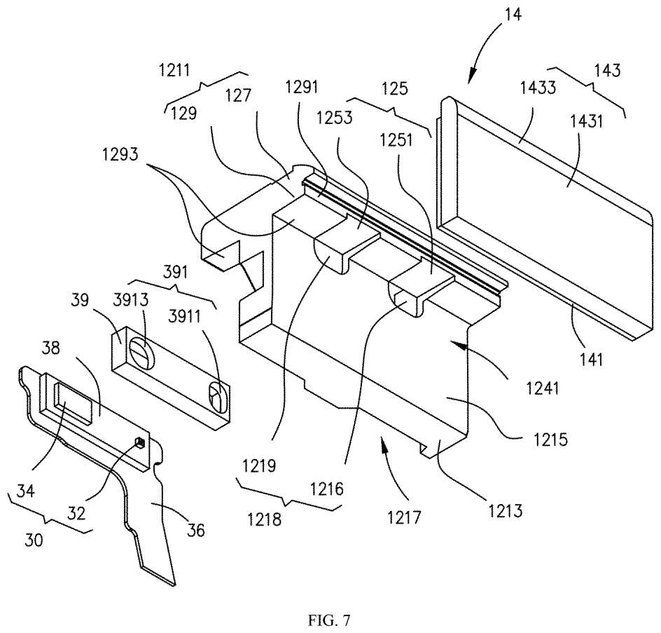

As illustrated in FIGS. 6 and 7, in some embodiments, the front shell 121 includes a mounting member 1213 connected to the frame 1211.

The frame 1211 and the mounting member 1213 may cooperatively form a front bezel of the electronic device 100. That is, the front shell 121 can serve as the front bezel of the electronic device 100. At this time, the rear shell 123 may include a side frame and a rear cover (none of which are illustrated in the drawings, as illustrated in FIG. 1). The rear shell 123 is disposed outside the front shell 121. The rear shell 123 and the screen assembly 14 together form an appearance structure of the electronic device 100.

It can be understood that, in other embodiments, the frame 1211 may also serve as a side frame of the electronic device 100. In this case, the rear shell 123 serves as a battery cover of the electronic device 100 and is disposed on one side of the frame 1211. It should be understood that the side frame of the electronic device 100 refers to a side periphery portion of the electronic device 100 in the thickness direction. The side frame is together with the rear shell of the electronic device 100 (such as the rear shell 123 serving as a battery cover) and a front side surface (such as the screen assembly 14) form an appearance of the electronic device 100. In some embodiments, the side frame of the electronic device 100 may be an integral structure with the front surface, or may be an integral structure with the rear shell, or may be an independent frame. A structure of the side frame is not limited herein. In the embodiment illustrated in the drawings, the frame 1211 is assembled with the rear shell 123 and the screen assembly 14.

In this embodiment, the mounting member 1213 is configured to support a printed circuit board, the sensor assembly 30 and other electronic components of the electronic device 100. The printed circuit board may be the main board of the electronic device 100. The mounting member 1213 is embedded with the frame 1211 so that the frame 1211 may surround the mounting member 1213. In this embodiment, the mounting member 1213 is substantially in the shape of a plate and is connected to the mounting surface 1293. In particular, the mounting member 1213 is received in the receiving space 1241 and substantially connected to a middle portion of the mounting surface 1293. The mounting member 1213 is substantially perpendicular to the mounting surface 1293. When the mounting member 1213 is disposed in in the frame 1211, the mounting member 1213 is located between the screen assembly 14 and the rear shell 123. In some embodiments, a material of the mounting member 1213 may include, but is not limited to, any one or a combination of metal, plastic, resin, glass, and rubber. In this embodiment, the mounting member 1213, the main body 127, and the support portion 129 are integrally formed. It can be understood that in other embodiments, the mounting member 1213, the main body 127, and the support portion 129 can be assembled together.

In some embodiments, the mounting member 1213 includes a first mounting surface 1215 and a second mounting surface 1217. The first mounting surface 1215 is disposed on a side of the mounting member 1213 facing the receiving space 1241. The second mounting surface 1217 is disposed on a side of the mounting member 1213 away from the receiving space 1241. In some embodiments, the mounting member 1213 defines a through hole 1218. The through hole 1218 is defined in a side of the mounting member 1213 adjacent to the support portion 129. The through hole 1218 is in communication with the at least one transmission channel 125. The through hole 1218 is configured to form a signal transmission path of the sensor assembly 30, cooperatively with the at least one transmission channels 125. Thus the sensor assembly 30 may transmit signals through the signal transmission path, so that the sensor assembly 30 can be disposed flexibly. In this embodiment, the through hole 1218 penetrates the first mounting surface 1215 and the second mounting surface 1217.

As illustrated in FIGS. 5, 7 and 8, in some embodiments, the sensor assembly 30 is connected to the second mounting surface 1217. The sensor assembly 30 transmits and/or receives signals with the through hole 1218 and the at least one transmission channel 125. In some embodiments, the sensor assembly 30 may include a transmitter 32 and a receiver 34. The transmitter 32 is configured to transmitting signals, and the receiver 34 is configured to receiving signals that is reflected by external objects. In some embodiments, in order to prevent the operation of the receiver 34 from being affected by the transmitter 32, the transmitter 32 and the receiver 34 may be arranged separately. For example, the mounting member 1213 may define two through holes 1218. The two through holes 1218 are spaced apart from each other, and the two through holes 1218 are respectively communicated with the at least one transmission channel 125. When the sensor assembly 30 is connected to the mounting member 1213, the transmitter 32 can be arranged corresponding to one of the through holes 1218, and the receiver 34 can be arranged corresponding to the other through holes 1218. In this way, signals emitted by the transmitter 32 can be prevented from interfering with a detection procedure of the receiver 34, thereby improving an accuracy of detection of the sensor assembly 30.

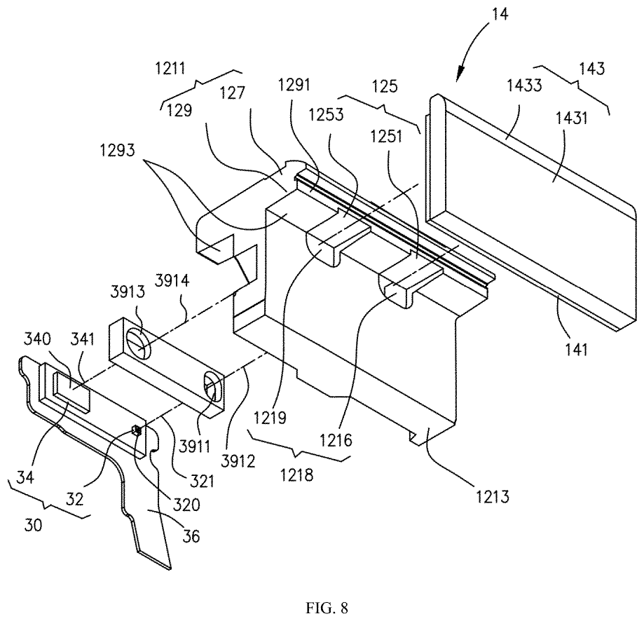

For example, in the embodiment illustrated in FIG. 7, the two through holes 1218 may include an emitting hole 1216 and a receiving hole 1219. The transmitter 32 is disposed corresponding to the emitting hole 1216. In particular, the transmitter 32 may include an emitting end 320 (as illustrated in FIG. 8) for emitting signals. The emitting end 320 is opposite to the emitting hole 1216. In some embodiments, the emitting end 320 is aligned with the emitting hole 1216. For example, the emitting end 320 may define an emitting axis 321 that indicates a direction of the signals emitted by the transmitter 32, and the emitting axis 321 may be substantially aligned with a center axis of the emitting hole 1216.

The receiver 34 is disposed corresponding to the receiving hole. In particular, the receiver 34 may include a receiving end 340 (as illustrated in FIG. 8) for receiving signals. The receiving end 340 is opposite to the receiving hole 1219. In some embodiments, the receiving end 340 is aligned with the receiving hole 1219. For example, the receiving end 340 may define a receiving axis 341 that indicates a direction of the signals received by the receiver 34, and the receiving axis 341 may be substantially aligned with a center axis of the receiving hole 1219.

In this illustrated embodiments, the at least one transmission channel 125 may include an emitting channel 1251 and a receiving channel 1253. The emitting channel 1251 and the receiving channel 1253 are spaced apart from each other in the support portion 129. The emitting hole 1216 communicates with the emitting channel 1251 to define a signal emitting channel for the transmitter 32. The receiving hole 1219 communicates with the receiving channel 1253 to define a signal receiving channel for the receiver 34. In this way, by providing independent signal emitting channel and signal receiving channel, it can avoid the signal emitted by the transmitter 32 interferes with a detection procedure of the receiver 34, thereby improving an accuracy of detection of the sensor assembly 30.

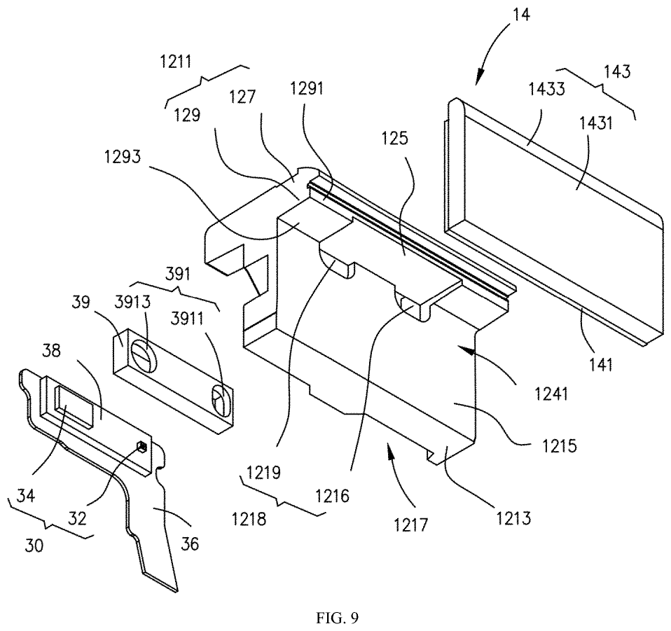

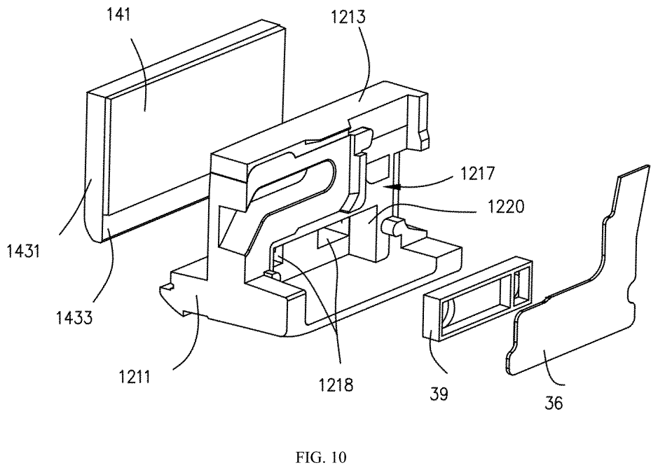

For another example, in the embodiment illustrated in FIG. 9 and FIG. 10, the two through hole 1218 may include an emitting hole 1216 and a receiving hole 1219. The transmitter 32 is disposed corresponding to the emitting hole 1216, and the receiver 34 is disposed corresponding to the receiving hole 1219. At this time, there is one transmission channel 125. The emitting hole 1216 and the receiving hole 1219 are respectively located on opposite sides of the at least one transmission channel 125. The emitting hole 1216 and the receiving hole 1219 are respectively communicated with the at least one transmission channel 125. In this way, the transmitter 32 is apart from the receiver 34 by the emitting hole 1216 and the receiving hole 1219, which can avoid the signal emitted by the transmitter 32 interferes with a detection procedure of the receiver 34. The at least one transmission channel 125 is in a wider groove structure, which can simplify the manufacturing procedure of the front shell 121, and reduce costs and improve production efficiency.

In some embodiments, the sensor assembly 30 may include, but not limited to, an infrared sensor, an ultrasonic sensor, a laser sensor, and a light sensor. In some embodiments, the sensor assembly 30 may include an infrared sensor such as an infrared proximity sensor. In this case, the transmitter 32 is an infrared transmitter, and the receiver 34 is an infrared receiver. The infrared sensor assembly works by infrared emission and infrared reception. For the electronic device 100, the transmitter 32 may emit infrared signals, and the infrared signals may be reflected by an external object, the receiver 34 may receive the infrared signals that are reflected. When the external object is closed to the electronic device 100, an intensity of the infrared signals received by the receiver 34 is relatively greater. When the external object is far away from the electronic device 100, an intensity of the infrared signals received by the receiver 34 is relatively smaller. The infrared sensor assembly may obtain a distance between the electronic device 100 and the external object based on the intensity of the infrared signals received by the receiver 34.

In some embodiments, the sensor assembly 30 may include an ultrasonic sensor such as an ultrasonic proximity sensor, or an ultrasonic gesture detecting sensor. In this case, the transmitter 32 is an ultrasonic transmitter, and the receiver 34 is an ultrasonic receiver. The ultrasonic sensor assembly works by ultrasonic emission and ultrasonic reception. For the electronic device 100, the transmitter 32 may emit ultrasonic signals, and the ultrasonic signals may be reflected by an external object, the receiver 34 may receive the ultrasonic signals that are reflected. When the external object is closed to the electronic device 100, an intensity of the ultrasonic signals received by the receiver 34 is relatively greater. When the external object is far away from the electronic device 100, an intensity of the ultrasonic signals received by the receiver 34 is relatively smaller. The ultrasonic sensor assembly may obtain a distance between the electronic device 100 and the external object based on the intensity of the ultrasonic signals received by the receiver 34.

In some embodiments, in some embodiments, the electronic device 100 further includes a flexible circuit board 36 and a substrate 38. The flexible circuit board 36 is disposed on the second mounting surface 1217 of the mounting member 1213 and is electrically coupled to a control board of the electronic device 100. The substrate 38 is disposed on a side of the flexible circuit board 36 facing the mounting member 1213. The transmitter 32 and the receiver 34 are disposed on the substrate 38 spaced from each other. A distance between a geometric center of the transmitter 32 and a geometric center of the receiver 34 may be 2-14 mm. The transmitter 32 and the receiver 34 can be separated spatially when the transmitter 32 is apart from the receiver 34, so as to reduce the influence of the signal transmitted by the transmitter 32 on the receiver 34. Of course, in other embodiments, the transmitter 32 and the receiver 34 may be arranged adjacent to each other, so as to reduce the size of the sensor assembly 30.

Further, in some embodiments, the electronic device 100 may include a protective member 39. The protective member 39 is stacked on a side of the substrate 38 facing the mounting member 1213 and covers the sensor assembly 30. The protective member 39 defines at least one transmission hole 391 therein. The at least one transmission hole 391 penetrates the protective member 39. The sensor assembly 30 is accommodated in the at least one transmission hole 391 and configured to transmit or/and receive signals with the transmission hole 391. In some embodiments, there are two transmission holes 391 defined in the protective member 39. The two transmission holes 391 include a first transmission hole 3911 with a center axis 3912 and a second transmission hole 3913 with a center axis 3914. The first transmission hole 3911 and the second transmission hole 3913 are spaced apart from each other. The transmitter 32 is accommodated in the first transmission hole 3911, and the emitting axis 321 is substantially aligned with the center axis 3912. The receiver 34 is accommodated in the second transmission hole 3913, and the receiving axis 341 is substantially aligned with the center axis 3914. In this way, the transmitter 32 and the receiver 34 can be separated from each other, so as to protect the receiver 34 from being affected by the transmitter 32.

In some embodiments, the transmitter 32, the receiver 34, and the substrate 38 are packaged as a chip structure to facilitate an assembly procedure of the sensor assembly 30. Alternatively, the transmitter 32, the receiver 34, the substrate 38, and the protective member 39 can be packaged as a chip structure to facilitate the assembly procedure of the sensor assembly 30 and improve production efficiency.

In some embodiments, in some embodiments, in order to accommodate the aforementioned chip structure to reduce an occupying space of the sensor assembly 30, the mounting member 1213 may define a recess 1220. The recess 1220 is defined in the second mounting surface 1217. The through hole 1218 penetrates a bottom wall of the recess 1220, so that the recess 1220 and the through hole 1218 are communicated with each other. The flexible circuit board 36 covers the recess 1220, so that the transmitter 32, the receiver 34, the substrate 38, and the protective member 39 are accommodated in the recess 1220, thereby making an internal structure of the electronic device 100 more compact, which makes the electronic device 100 thinner.

As illustrated in FIGS. 5 and 8, the screen assembly 14 is connected to the frame 1211 of the housing 12. The screen assembly 14 is opposite to the mounting member 1213 and spaced apart from the mounting member 1213.

In this embodiment, the screen assembly 14 includes a display module 141 and a cover plate 143. The cover plate 143 is disposed on the frame 1211. The cover plate 143 and the frame 1211 are connected together by glue (in particular, optical transparent glue or other adhesive). The cover plate 143 may be made of a transparent material, which serves as a transparent panel of the screen assembly 14 and can be configured to protect the display module 141 from scratches. In some embodiments, the cover plate 143 may be a glass cover plate, a resin cover plate, a sapphire cover plate, or the like.

The display module 141 is disposed on a side of the cover plate 143 facing the mounting member 1213. The display module 141 and the cover plate 143 are connected together by optically clear adhesive (OCA, not illustrated in the drawings). In this embodiment, the cover plate 143 does not completely cover the entire surface of the display module 141. That is, when the display module 141 is attached to the cover plate 143, there is a rest portion between an edge of the cover plate 143 and an edge of the display module 141. A preset distance between the edge of the cover plate 143 and the edge of the display module 141 is defined by the rest portion. The rest portion is configured to connect to the frame 1211, thus the cover plate 143 can be attached to the frame 1211. Therefore, a gap is defined by the edge of the display module 141 and the frame 1211. Due to the existence of the gap and the rest portion for attaching the cover plate 143 to the frame 1211, after the light 1410 emitted by the display module 141 passes through the cover plate 143, the edge and the rest portion of the cover plate 143 forms a black border because the light 1410 may not pass through the rest portion or the light 1410 passing through the rest portion is very weak. The cover 143 can be divided into a display portion 1431 and a non-display portion 1433. The display portion 1431 overlaps the display module 141, and the non-display portion 1433 is an area of the cover 143 except the display portion 1431. In short, the non-display portion 1433 can be considered as the black border of the cover plate 143.

The cover plate 143 is connected to the support portion 129 via the non-display portion 1433. In particular, the non-display portion 1433 is stacked on the support surface 1291 of the support portion 129 and is disposed on one end of the at least one transmission channel 125. The sensor assembly 30 is opposite to the non-display portion 1433 via the at least one transmission channel 125. The sensor assembly 30 can transmit an d/or receive signals through the at least one transmission channel 125 and the non-display portion 1433. For example, the sensor assembly 30 is configured to emit signal to pass through the at least one transmission channel 125 and the non-display portion 1433, and receive signals from outside and pass through the non-display portion 1433 and the at least one transmission channel 125.

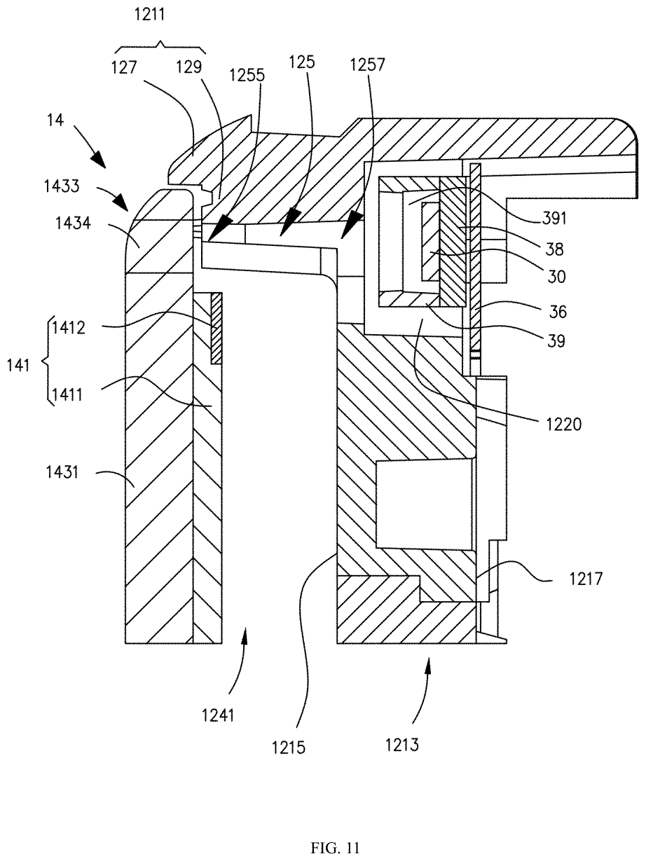

In some embodiments, as illustrated in FIG. 11, the display module 141 may include a display screen 1411 and a drive circuit 1412. The display screen 1411 is an area of the display module 141 that contacts with the cover plate 143. The drive circuit 1412 is disposed on a side of the display module 141 away from the cover plate 143, and located at an edge of the display module 141. At this time, due to the existence of the drive circuit 1412, a part of the display screen 1411 that overlaps the drive circuit 1412 cannot emit light, so the display screen 1411 can be divided into a sub-display portion and a sub-non-display portion. At this time, the display portion 1431 of the cover 143 may be an area of the cover plate 143 located above the sub-display portion. The non-display portion 1433 of the cover plate 143 may be a combination of an area of the cover plate 143 located above the sub-non-display portion and an area from the foregoing mentioned area to the edge of the cover plate 143. It should be understood that the non-display portion 1433 of the cover plate 143 can be considered as the black border as known.

Therefore, in the electronic device 100 provided by the embodiments of the present disclosure, the black border of the display assembly 10 is stacked on the support portion 129 of the frame 1211. The at least one transmission channel 125 is defined in the support portion 129, which can make full use of the black border and the gap defined by the connection structure of the frame 1211 and the display assembly 14, to form a signal transmission channel or path for the sensor assembly 30. Therefore, the sensor assembly 30 can be rationally arranged without embedding into the black border of the screen assembly 14, thus avoiding occupying the side frame of the electronic device 100, which is conducive to achieve a full-screen for the electronic device 100.

In some embodiments, the non-display portion 1433 may include a transmission region 1434. The transmission region 1434 is aligned with the at least one transmission channel 125, and configured to allow the signals of the sensor assembly 30 to pass through, thereby preventing the non-display portion 1433 from shielding the signals of the sensor assembly 30. In some embodiments, the transmission region 1434 may be in the shape of a hole or an area coated with ink. The ink is configured to filter visible light and ensure that an appearance of the transmission region 1434 is the same or similar to an appearance of other regions of the non-display portion 1433.

In some embodiments, a position of the sensor assembly 30 with respect to the mounting member 1213 is not limited. For example, in the above-provided embodiments, the sensor assembly 30 is disposed on a side of the mounting member 1213 away from the screen assembly 14 (e.g. the second mounting surface 1217). The sensor assembly 30 may transmit or/and receive signals through the through hole 1218 and the at least one transmission channel 125. Alternatively, in some embodiments, the sensor assembly 30 may be disposed on a side of the mounting member 1213 facing the screen assembly 14 (e.g. in particular, the first mounting surface 1215), and the sensor assembly 30 is disposed corresponding to the at least one transmission channel 125, and can transmit or/and receive signals through the at least one transmission channel 125. Alternatively, in some other embodiments, the sensor assembly 30 may be disposed in the at least one transmission channel 125 and connected to the support portion 129, so that the sensor assembly 30 can transmit or/and receive signals through the at least one transmission channel 125.

It can be understood that, in some embodiments, a position of the sensor assembly 30 with respect to the frame 1211 is not limited. For example, the sensor assembly 30 may be located at a top portion of the electronic device 100. At this time, the at least one transmission channel 125 is defined in the top portion of the electronic device 100. In some embodiments, the at least one transmission channel 125 may be defined in a substantially middle portion of the top portion of the electronic device 100, to facilitate the sensor assembly 30 to accurately sense the distance between the external object and the electronic device 100. In particular, the electronic device 100 may include a receiver (also called a receiver, not illustrated in the drawings) disposed in the housing 12. The housing 12 defines a sound hole 70 corresponding to the receiver (as illustrated in FIGS. 1 and 3). The sound hole 70 is substantially located at the top portion of the electronic device 100. The sound hole 70 is disposed adjacent to the sensor assembly 30. In other words, the sensor assembly 30 is adjacent to the sound hole 70 and is disposed at one side of the sound hole 70, so as to more accurately detect the distance between the user's ear/face and the electronic device 100. When the user moves the electronic device 100 to the face or ear thereof (for example, when answering or making a call), the sensor assembly 30 may work more accurately. Therefore, the screen assembly 14 may be turned off or turned on according to the distance between the electronic device 100 and the user's face/ear.

In some embodiments, when the sensor assembly 30 is disposed on the top portion of the electronic device 100, the frame 1211 may include a first sub-frame 1201 and a second sub-frame 1203 (as illustrated in FIG. 2) opposite to the first sub-frame 1201. The first sub-frame 1201 and the second sub-frame 1203 are substantially parallel to each other. The screen assembly 14 is disposed between the first sub-frame 1201 and the second sub-frame 1203. The first sub-frame 1201 serves as a “top” frame of the electronic device 100, and the second sub-frame 1203 serves as a “bottom” frame of the electronic device 100. The first sub-frame 1201 defines a sound channel corresponding to the sound hole 70. The sound channel is disposed between the sound hole 70 and the receiver for allowing sound waves to transmit. At this time, the at least one transmission channel 125 is defined in the first sub-frame 1201 adjacent to the sound channel.

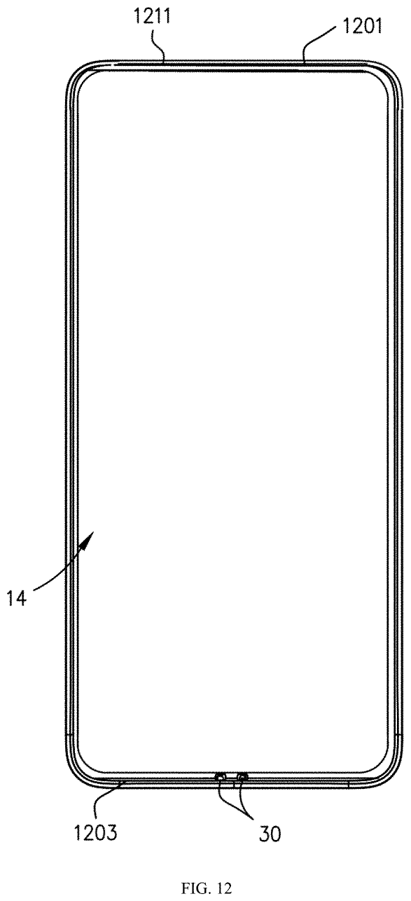

Alternatively, in some embodiments, as illustrated in FIG. 12, the sensor assembly 30 may be disposed on a bottom portion of the electronic device 100. At this time, the at least one transmission channel 125 may be defined in the bottom portion of the electronic device 100. In particular, the at least one transmission channel 125 can be defined in the second sub-frame 1203, so that the sensor assembly 30 can be disposed on a portion except the top portion that supports multiple components. Therefore, the sensor assembly 30 can have a larger installation space for assembling, which makes an assembly procedure of the electronic device 100 easier.

Alternatively, the sensor assembly 30 may be disposed adjacent to a left side of the electronic device 100. At this time, the at least one transmission channel 125 is defined in the left side of the electronic device 100. Alternatively, the sensor assembly 30 may be disposed adjacent to a right side of the electronic device 100. At this time, the at least one transmission channel 125 is defined in the right side of the electronic device 100.

It can be understood that, in some embodiments, the at least one transmission channel 125 may be a channel structure other than a groove structure. For example, the at least one transmission channel 125 may have a through-hole, which is defined in the support portion 129 and penetrates the support portion 129. The non-display portion 1433 of the screen assembly 14 and the sensor assembly 30 are located at opposite ends of the through-hole. The sensor assembly 30 can receive or/and transmit signals in avail of the through-hole and the non-display portion 1433.

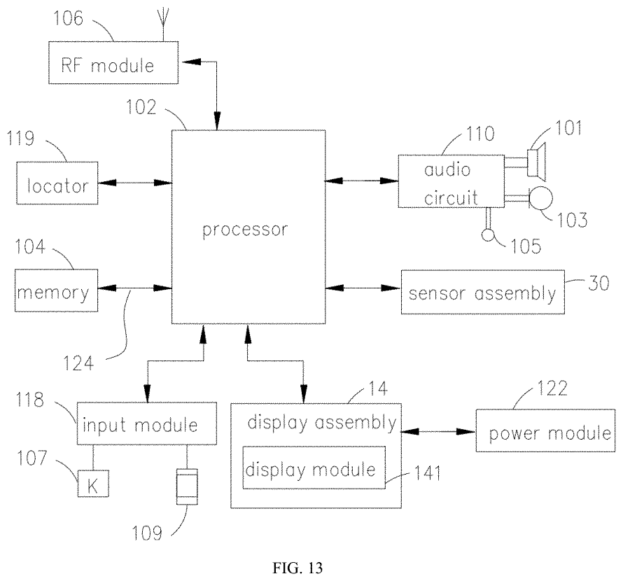

As illustrated in FIG. 13, in accordance with the embodiments of the present disclosure, in an actual disclosure scenario, the electronic device 100 can be used as a smart phone terminal, in which case the electronic device 100 typically further includes one or more (only one illustrated in FIG. 13) processor 102, memory 104, the radio frequency (RF) module 106, an audio circuit 110, a sensor, an input module 118, and a power module 122. It will be understood by those skilled in the art that the structure illustrated in FIG. 13 is merely illustrative and does not limit a structure of the electronic device 100. For example, the electronic device 100 may further include more or less components than those illustrated in FIG. 13, or have a different configuration than that illustrated in FIG. 13.

It will be understood by those skilled in the art that all other components are peripherals relative to the processor 102. The processor 102 is coupled to the peripherals via a plurality of peripheral interfaces 124. The peripheral interface 124 can be implemented based on the following standards: Universal Asynchronous Receiver/Transmitter (UART), General Purpose Input Output (GPIO), Serial Peripheral Interface (SPI)), Inter-Integrated Circuit (I2C), but not limited to the above standards. In some embodiments, the peripheral interface 124 may only include a bus. In other embodiments, the peripheral interface 124 may also include other elements, such as one or more controllers, such as a display controller or a memory controller configured to connect the memory. In addition, these controllers can also be separated from the peripheral interface 124 and integrated into the processor 102 or corresponding peripherals.

The memory 104 can be configured to store software programs and modules. The processor 102 is configured to execute various functional disclosures and data processing by running software programs and modules stored in the memory 104. The memory 104 may include a high-speed random access memory, and may also include a non-volatile memory, such as one or more magnetic storage devices, flash memory, or other non-volatile solid-state memory. In some examples, the memory 104 may further include a memory remotely provided with respect to the processor 102. These remote memories may be connected to the processor 102 or the screen assembly 14 of the electronic device 100 vis a network. Examples of the aforementioned networks include, but are not limited to, the Internet, corporate intranets, local area networks, mobile communication networks, and combinations thereof.

The radio frequency module 106 is configured to receive and transmit electromagnetic waves, and realize mutual conversion between electromagnetic waves and electric signals. Therefore, the electronic device 100 is capable of communicating with a network or other devices. The radio frequency module 106 can include various existing circuit components for performing these functions, such as an antenna, a radio frequency transceiver, a digital signal processor, an encryption/decryption chip, a Subscriber Identity Module (SIM) card, a memory, etc. The radio frequency module 106 can communicate with various networks such as the Internet, an intranet, a wireless network, or communicate with other devices through a wireless network. The above-mentioned wireless network can use various communication standards, protocols and technologies, including but not limited to Global System for Mobile Communication (GSM), Enhanced Data GSM Environment (EDGE), broadband code Wideband code division multiple access (W-CDMA), code division multiple access (CDMA), time division multiple access (TDMA), wireless fidelity (Wireless, Fidelity), Wi-Fi) (such as the American Institute of Electrical and Electronics Engineers standard IEEE 802.10A, IEEE 802.11b, IEEE802.11g and/or IEEE 802.11n), Internet telephony (Voice over interne protocol, VoIP), Worldwide Interoperability for Microwave Access, Wi-Max), other protocols for email, instant messaging and short messages, and any other suitable communication protocols, even those that have not yet been developed.

The audio circuit 110, the speaker 101, the sound jack 103, and the microphone 105 collectively provide an audio interface on the electronic device 100 or the display assembly 14 for a user. In particular, the audio circuit 110 receives sound data from the processor 102, converts the sound data into electrical signals, and transmits the electrical signals to the speaker 101. The speaker 101 converts electrical signals into sound waves that can be heard by human ears. The audio circuit 110 also receives electrical signals from the microphone 105, converts the electrical signals into sound data, and transmits the sound data to the processor 102 for further processing. The audio data can be obtained from the memory 104 or through the radio frequency module 106. In addition, the audio data can also be stored in the memory 104 or sent via the radio frequency module 106.

The sensors are disposed within housing 12 or within the display assembly 14. Examples of the sensors can include, but are not limited to, proximity sensors, operational sensors, pressure sensors, gravity acceleration sensors, and other sensors. In addition, the electronic device 100 can also be configured with other sensors such as a gyroscope, a barometer, a hygrometer, a thermometer, and the like, and details are not described herein again.

In this embodiment, the input module 118 may include a touch screen 109 provided in the screen assembly 14. The touch screen 109 may collect user's touch operations on or near it (for example, the user uses a finger, a stylus, or any other suitable object or accessory operation on the touch screen 109 or near the touch screen 109), and drive the corresponding device according to a preset program. Optionally, the touch screen 109 may include a touch detection device and a touch controller. The touch detection device may detect the user's touch position, and detects signals generated according the touch operation, and transmits the signals to the touch controller. The touch controller may receive the touch information from the touch detection device and convert the touch information into contact coordinates. Then sent to the processor 102, and can receive the command sent by the processor 102 and execute it. In addition, multiple types such as resistive, capacitive, ultrasonic, and surface acoustic wave can be used to implement the touch detection function of the touch screen 109. In addition to the touch screen 109, in other modified implementation manners, the input module 118 may also include other input devices, such as keys 107. The keys 107 may include, for example, character keys for inputting characters, and control keys for triggering control functions. Examples of control buttons include a “return to main screen” button, a power on/off button, and so on.

The screen assembly 14 is configured to display various graphical user interfaces for information input by the user and information of the electronic device 100 provided to the user. These graphical user interfaces may be composed of graphics, text, icons, numbers, videos, and any combination thereof. In one example, the touch screen 109 can be disposed on the display assembly 14 to be integrated with the display assembly 14.

Further, the display screen 1411 of the screen assembly 14 may be a liquid crystal display (Liquid Crystal Display, LCD) or an organic light-emitting diode (OLED) display. When the display screen 1411 is a liquid crystal display, it may also include a backlight plate, a lower polarizer, an array substrate, a liquid crystal layer, a color filter substrate, an upper polarizer and other structures stacked in sequence. When the display screen 1411 is an organic light emitting diode display screen, it may also include a base layer, an anode, an organic layer, a conductive layer, an emission layer, a cathode, and other structures stacked in sequence.

The power module 122 is configured to provide power to the processor 102 and other components. In the illustrated embodiment, the power module 122 may include a power management system, one or more power sources (such as a battery or an alternating current), a charging circuit, a power failure detecting circuit, an inverter, a power status indicator, and any other component which is related to the generation, management, and distribution of power within electronic device 100 or the display assembly 14.

The electronic device 100 can also include a locator 119 for determining the actual location at which the electronic device 100 is located. In this embodiment, the locator 119 applies a location service to implement the positioning of the electronic device 100. The positioning service should be understood as a technology or service of the location of the object being located, which is configured to acquire the location information (such as latitude and longitude coordinates) of the electronic device 100 by using a specific positioning technology, and marking the electronic map.

It should be understood that the electronic device 100 described above is not limited to a smartphone terminal, it should refer to a computer device that can be used in mobile. Specifically, the electronic device 100 refers to a mobile computer device equipped with a smart operating system, including but not limited to a smart phone, a smart watch, a notebook, a tablet computer, a POS machine, and even an in-vehicle computer, and the like.

In some embodiments, as illustrated in some embodiments, the electronic device 100 may be a full-screen electronic device. The full-screen electronic device should be considered as an electronic device having a screen ratio greater than or equal to a preset value. That is, when the display assembly 14 is disposed on the front side of the housing 12, the percentage of the surface area of the display assembly 14 and the projected area of the front surface of the housing 12 is greater than or equal to a preset value. In some embodiments, the preset value of the screen ratio may be greater than or equal to 74%, such as 74%, 75%, 76%, 78%, 79%, 80%, 81%, 83%, 85%, 87%. 89%, 90%, 91%, 93%, 95%, 97%, 99%, etc. In some embodiments, a front side of the full-screen electronic device may be provided with three or fewer physical keys (such as key 107). And/or, the front side of the full-screen electronic device may be provided with two or fewer openings. Therefore, a structure of the full-screen electronic device can be simplified; and it is beneficial to increase the screen ratio of the full-screen electronic device.

According to the electronic device 100 described above, the present disclosure also provides another electronic device, in accordance with an embodiment of the present disclosure. the electronic device includes a housing, a screen assembly, and a sensor assembly. The housing, defines at least one transmission channel therein. The screen assembly is connected to the housing. The screen assembly includes a display portion and a non-display portion. The non-display portion is connected to an edge of the display portion. The non-display portion being attached to the housing. The sensor assembly is disposed in the housing. The sensor assembly and the non-display portion are respectively located at two opposite ends of the at least one transmission channel. The non-display portion defines a transmission region. The transmission region is aligned to the at least one transmission channel and configured to allow signals from the sensor assembly to pass through.

In some embodiments, the transmission channel is defined in a frame of the housing. The transmission channel is a through-hole. The non-display portion and the proximity sensor are located respectively at two opposite ends of the through-hole.

In some embodiments, the transmission channel is a groove. The groove is defined in a side of the housing facing the receiving space. The non-display portion and the proximity sensor are respectively located at two opposite ends of the groove.

In some embodiments, the housing includes a frame and a mounting member. The at least one transmission channel is defined in the frame. The mounting member is connected to the frame and opposite to the screen assembly. The sensor assembly is connected to the mounting member.

In some embodiments, the frame includes a mounting surface facing the mounting member and a support surface departing from the mounting member. The at least one transmission channel is defined in the mounting surface and penetrates the support surface. The screen assembly included a display module and a cover plate covering a surface of the display module. The cover plate does not completely cover the entire surface of the display module. The non-display portion is a portion of the cover plate which is not overlaps the display module, and the non-display portion is disposed on the support surface and covering the first end. The display module is opposite to the mounting member.

In some embodiments, the screen assembly includes a display module and a cover plate covering a surface of the display module. The cover plate does not completely cover the entire surface of the display module. The non-display portion is a portion of the cover plate which is not overlaps the display module, and attached to the frame while covering the first end.

In some embodiments, the sensor assembly includes at least one of an infrared sensor, an ultrasonic sensor, a laser sensor, and a light sensor

In the description, the terms “connected” and “coupled” is used for indicates that there is a combination of two components, and one of the two components may be directly connected to the other component, or one of the two components may be indirectly connected to the other component via an connector such as a binder or other physical connection. In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “a plurality of” means at least two, such as two, three, etc., unless specifically defined otherwise.ls or characteristics can be combined in any one or more embodiments or examples in a suitable manner, without contradicting each other.

The technical features of the embodiments described above can be arbitrarily combined. In order to simplify the description, all possible combinations of the technical features in the above embodiments have not been described. However, as long as there is no contradiction in the combination of these technical features, it should be considered as the scope described in this specification.

The above-mentioned embodiments only express several implementation manners of the present disclosure, and their descriptions are more specific and detailed, but they cannot be understood as a limitation on the scope of patent disclosure. It should be noted that, for those of ordinary skill in the art, without departing from the concept of the present disclosure, several modifications and improvements can be made, which all belong to the protection scope of the present disclosure. Therefore, the protection scope of this disclosure patent shall be subject to the appended claims.

What is claimed is:

1. An electronic device, comprising:
a frame, defining a receiving space and at least one transmission channel communicating with the receiving space, the at least one transmission channel comprising a first end and a second end opposite to the first end;
a screen assembly, connected to the frame, the screen assembly comprising a display portion and a non-display portion connected to the display portion, the non-display portion covering the first end; and
a sensor assembly, disposed in the receiving space;
wherein the sensor assembly is adjacent to the second end, and opposite to the non-display portion via the at least one transmission channel;
wherein the sensor assembly is configured to transmit signals to pass through the at least one transmission channel and the non-display portion, and/or receive signals that passes though the non-display portion and the at least one transmission channel.

2. The electronic device of claim 1, wherein:
the electronic device comprises a receiver disposed in the receiving space;
the frame defines a sound channel for the receiver.

3. The electronic device of claim 2, wherein:
the frame comprises a first sub-frame and a second sub-frame opposite to the first sub-frame;
the screen assembly is disposed between the first sub-frame and the second sub-frame;
the receiver is adjacent to the first frame;
the first sub-frame defines a sound channel for the receiver;
the at least one transmission channel is defined in the first sub-frame or in the second sub-frame.

4. The electronic device of claim 1, wherein:
the non-display portion comprises a transmission region for allowing signals from the sensor assembly to pass through;
the transmission region is disposed opposite to the sensor assembly, and the sensor assembly is configured to transmit signals to pass through the at least one transmission channel and the non-display portion, and receive signals that passes though the non-display portion and the at least one transmission channel.

5. The electronic device of claim 1, wherein:
the at least one transmission channel penetrates two opposite ends of the frame;
the non-display portion and the sensor assembly are respectively disposed at two opposite ends of the at least one transmission channel.

6. The electronic device of claim 4, wherein:
the transmission channel is a groove;
the groove is defined in a side of the frame facing the receiving space;
the non-display portion and the sensor assembly are respectively disposed at two opposite ends of the groove.

7. The electronic device of claim 1, wherein:
the frame comprises a main body and a support portion; the support portion protrudes from a side of the main body facing the receiving space;
the at least one transmission channel is defined in the support portion; the non-display portion overlaps on the support portion and is attached to the support portion.

8. The electronic device of claim 7, wherein:
the support portion comprises a support surface connected to the main body;
the non-display portion is stacked on the support surface;
the first end of the at least one transmission channel penetrates the support surface.

9. The electronic device of claim 7, wherein:
the electronic device comprises a mounting member;
the mounting member is connected to the support portion and disposed opposite to the screen assembly;
the sensor assembly is connected to the mounting member.

10. The electronic device of claim 9, wherein:
the mounting member comprises a first mounting surface facing the screen assembly and a second mounting surface away from the screen assembly; the mounting member defines at least one through hole therein;
the at least one through hole penetrates the first mounting surface and the second mounting surface and communicates with the at least one transmission channel;
the sensor assembly is connected to the second mounting surface and aligned with the through hole.

11. The electronic device of claim 10, wherein:
the at least one through hole comprises an emitting hole and a receiving hole spaced apart from the emitting hole;
the emitting hole and the receiving hole are both communicates with the at least one transmission channel; the sensor assembly comprises a transmitter and a receiver;
the transmitter is aligned with the emitting hole and configured to emit signals to pass through the emitting hole and the at least one transmission channel;
the receiver is aligned with the receiving hole and configured to receive signals that pass through the at least one transmission channel and the receiving hole.

12. The electronic device of claim 11, wherein:
the at least transmission channel comprises an emitting channel and a receiving channel;
the emitting channel and the receiving channel are spaced apart from each other;
the emitting hole is in communication with the emitting channel, and the receiving hole is in communication with the receiving channel.

13. The electronic device of claim 10, wherein:
the second mounting surface defines a recess;
the recess communicates with the at least one through hole;
the sensor assembly is disposed in the recess.

14. The electronic device of claim 13, wherein:
the electronic device comprises a flexible circuit board; the flexible circuit board covers the recess;
the sensor assembly is disposed on a side of the flexible circuit board facing the recess, such that the sensor assembly is received in the recess.

15. The electronic device of claim 14, wherein: the electronic device comprises a protective member;
the protective member is accommodated in the recess and covers the sensor assembly;
the protective member defines at least one transmission hole;
the sensor assembly is configured to transmit signals to pass through the transmission hole or/and receive signals that pass through the transmission hole.

16. The electronic device of claim 1, wherein:
the sensor assembly comprises a transmitter and a receiver, and both the transmitter and the receiver are opposite to the non-display portion via the at least one transmission channel;
the transmitter and the receiver are spaced apart from each other.

17. The electronic device of claim 16, wherein:
the at least one transmission channel comprises a emitting channel and a receiving channel;
the emitting channel is spaced apart from the receiving channel;
the transmitter corresponds to the emitting channel and is opposite to the non-display portion via the emitting channel;
the receiver corresponds to the receiving channel and is opposite to the non-display portion via the receiving channel.

18. An electronic device, comprising:
a housing, defining at least one transmission channel therein;
a screen assembly, connected to the housing; the screen assembly comprising a display portion and a non-display portion; the non-display portion being connected to an edge of the display portion; the non-display portion being attached to the housing; and
a sensor assembly, disposed in the housing; wherein the sensor assembly and the non-display portion are respectively located at two opposite ends of the at least one transmission channel;
wherein the non-display portion defines a transmission region;
wherein the transmission region is aligned to the at least one transmission channel and configured to allow signals from the sensor assembly to pass through.

19. The electronic device of claim 18, wherein: the housing comprises a frame and a mounting member;
the at least one transmission channel is defined in the frame;
the mounting member is connected to the frame and opposite to the screen assembly;
the sensor assembly is connected to the mounting member.

20. A front shell for an electronic device, comprising:
a frame and a mounting member connected to the frame;
wherein the frame comprises a mounting surface and a support surface connected to the mounting surface, the mounting surface being an interior surface of the frame and defines a receiving space for accommodate electronic components of the electronic device;
wherein the mounting member is connected to the mounting surface, the support surface departs from the mounting member, the frame defining at least one transmission channel communicating with the receiving space, the at least one transmission channel penetrating the support surface; and
wherein the support surface is configured to support a display assembly of the electronic device, the at least one transmission channel being covered by the display assembly when the display assembly is disposed on the support surface.
